(19) United States
(12) Patent Application Publication
(10) Pub. No.: US 2026/0129691 A1
(43) Pub. Date: May 7, 2026

(54) Method of VoWiFi Call Launch Fail Handover to VoLTE/VoNR

(71) Applicant: MEDIATEK INC., Hsinchu City (TW)

(72) Inventor: Chun-Li Kuo, Hsinchu City (TW)

(73) Assignee: MEDIATEK INC., Hsinchu City (TW)

(21) Appl. No.: 18/939,487

(22) Filed: Nov. 6, 2024

(51) Int. Cl. H04W 76/10; H04W 84/12

(52) U.S. Cl. CPC H04W 76/10; H04W 84/12

(57) ABSTRACT

A method of call handover performed by a UE, includes initiating a MO call using a VoWiFi service, detecting a failure of the MO call using the VoWiFi service, determining whether voice calling is supported by a cellular network in response to detecting the failure, performing a handover of an IMS PDN connection from the Wi-Fi network to the cellular network if the voice calling is supported by the cellular network, and retrying the MO call using the cellular network. This method enhances user experience by making the transition between Wi-Fi and cellular networks as seamless and imperceptible as possible. This seamless operation maintains the illusion of a single, unified communication system for the user, despite the complex interplay of different network technologies working behind the scenes.

### BACKGROUND

Mobile communication networks have evolved to offer voice services over various technologies, including traditional cellular networks and, more recently, Wi-Fi networks. Voice over Wi-Fi (VoWiFi), also known as Wi-Fi Calling, has become an important feature for mobile network operators and users alike, offering improved indoor coverage and potential cost savings.

The 3GPP specification, which defines the IP multimedia call control protocol based on Session Initiation Protocol (SIP) and Session Description Protocol (SDP), provides guidelines for handling IP multimedia subsystem (IMS) sessions, including voice calls over Wi-Fi and cellular networks. This specification outlines procedures for IMS registration, session establishment, and error handling.

However, despite the procedures outlined in the relevant 3GPP specification, Wi-Fi networks can be less reliable for voice calls due to various factors such as interference, network congestion, and limited range. When a mobile originating (MO) call fails on a Wi-Fi network, current standard options as implemented by many devices are limited to: 1) End the call, which results in a poor user experience; 2) Retry the call on the current network (Wi-Fi), which is often ineffective if the network conditions haven't changed.

While the relevant 3GPP specification does provide some guidance on error handling and network selection, it does not specifically address seamless transition between Wi-Fi and cellular networks in the event of call setup failures. The specification focuses more on maintaining registration and handling ongoing calls rather than optimizing the initial call setup process across different access technologies.

The standard approaches to handling Wi-Fi calling failures often overlook a crucial advancement in modern mobile device technology: the ability to maintain simultaneous connections to both Wi-Fi and cellular networks. This dual-connectivity capability, prevalent in many contemporary smartphones and tablets, opens up a new realm of possibilities for sophisticated call handling mechanisms. By leveraging this feature, devices can maintain an active cellular connection even while primarily using Wi-Fi for calls, creating a ready fallback option. This simultaneous connectivity allows for more nuanced and responsive call management strategies. For instance, when a Wi-Fi call begins to degrade or fail, the device can swiftly transition to the already-established cellular connection without the need for a time-consuming network search and registration process. This capability also enables real-time quality comparisons between Wi-Fi and cellular networks, potentially allowing for preemptive switches to the better-performing network before call quality degrades noticeably. Moreover, dual connectivity can facilitate seamless handovers in challenging environments where Wi-Fi coverage is spotty or inconsistent, ensuring call continuity as users move between different network coverage areas. By tapping into this dual-connectivity feature, more advanced call handling systems can significantly enhance call reliability, reduce latency in network transitions, and ultimately provide a much smoother and more resilient calling experience for users.

There is a need for an improved method of handling Wi-Fi calling failures that can leverage the ability of the device to connect to multiple networks. Such a method should aim to provide a seamless user experience by quickly transitioning to an alternative network when Wi-Fi calling encounters issues, thereby reducing call drops and minimizing user-perceived connection problems.

### SUMMARY

An embodiment discloses a method of call handover, performed by a user equipment (UE). The method comprises initiating a mobile originating (MO) call using a Voice over Wi-Fi (VoWiFi) service, detecting a failure of the MO call using the VoWiFi service, determining whether voice calling is supported by a cellular network in response to detecting the failure, performing a handover of a IP Multimedia Subsystem (IMS) Packet Data Network (PDN) connection from the Wi-Fi network to the cellular network if the voice calling is supported by the cellular network, and retrying the MO call using the cellular network.

An embodiment provides a user equipment (UE) comprising a memory and a processor coupled to the memory. The processor is used to initiate a mobile originating (MO) call using a Voice over Wi-Fi (VoWiFi) service, detect a failure of the MO call via the VoWiFi service, determine whether voice calling is supported by a cellular network in response to detecting the failure, perform a handover of an IP Multimedia Subsystem (IMS) Packet Data Network (PDN) connection from the Wi-Fi network to the cellular network if the voice calling is supported by the cellular network, and retry the MO call using the cellular network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a scenario in which a UE communicates with an IMS server.

FIG. 2 depicts a message sequence diagram of UE communicating with the IMS server according to the embodiments.

FIG. 3 depicts another message sequence diagram of UE communicating with the IMS server according to the embodiments.

FIG. 4 depicts a flowchart of a call handover method according to the embodiments.

FIG. 5 depicts a simplified block diagram of a user equipment (UE) according to the embodiments.

### DETAILED DESCRIPTION

This detailed description provides a comprehensive overview of the disclosure. While numerous specific details are presented to ensure a thorough understanding, those skilled in the art will recognize that the invention can be implemented without all these details. Some well-established methods, procedures, components, and circuits are not described in exhaustive detail to maintain focus on the key aspects of the disclosure. The primary context for this invention is the interoperability between 3GPP-specified wireless networks (e.g., as 4G and 5G) and IEEE 802.11 specified wireless networks (e.g., Wi-Fi). However, it is important to note that the principles described here can be adapted and applied to other cellular and non-cellular wireless network technologies as well. This broader applicability underscores the versatility and potential impact of the disclosed innovations in the field of wireless communications.

Wireless communication systems have evolved through multiple generations, each introducing new Radio Access Technologies (RATs) to improve spectrum utilization and user experience. These RATs, including Code Division Multiple Access (CDMA), Time Division Multiple Access (TDMA), Orthogonal Frequency Division Multiple Access (OFDMA), and Single Carrier Frequency Division Multiple Access (SC-FDMA), define how radio resources are used and shared among users. The 3rd Generation Partnership Project (3GPP) has been instrumental in standardizing these technologies.

The network architecture in these systems comprises two main components: the Radio Access Network (RAN) and the Core Network (CN). The RAN is the part of a mobile network that implements these RATs and includes various types of base stations, such as evolved Node B (eNodeB or eNB) for Long-Term Evolution (LTE) and next-generation Node B (gNodeB or gNB) for 5G New Radio (NR). These base stations are responsible for the radio interface between the network and user equipment (UE), managing radio resources, performing scheduling, and handling handovers. The RAN may include macrocells for wide area coverage, as well as smaller cells like picocells and femtocells for enhanced capacity and indoor coverage.

Different generations of mobile networks have distinct RAN architectures. For example, Global System for Mobile Communications (GSM) used Base Transceiver Stations (BTS), Universal Mobile Telecommunications System (UMTS) used Node B, LTE introduced eNodeB, and 5G NR uses gNodeB. Each generation's RAN is designed to implement its specific RAT efficiently.

Modern wireless systems often incorporate multiple generations of technology. For instance, 4G LTE networks use OFDMA for downlink and SC-FDMA for uplink, typically operating between 600 MHz and 2.6 GHz. 5G NR introduces more flexibility in subcarrier spacing and operates on a wider range of frequencies, including millimeter wave (mmWave) bands above 24 GHz. These cellular systems coexist with Wi-Fi networks, which operate in bands such as 2.4 GHz and 5 GHz according to Institute of Electrical and Electronics Engineers (IEEE) 802.11 standards.

The CN, evolving from the Evolved Packet Core (EPC) in LTE to the 5G Core (5GC) in 5G, manages overall network functionality, including mobility management, session management, and interworking with external networks. The CN is a fundamental component of a mobile network infrastructure that serves as the central part of the system, providing various services to customers who are connected by the access network. It is responsible for key functions such as routing calls and data connections, managing subscriber information, handling mobility management, and interconnecting with external networks like the public switched telephone network (PSTN) or the internet. In modern cellular networks, such as 4G LTE and 5G, the Core Network is largely software-based and virtualized, allowing for greater flexibility and scalability. It includes elements like the Mobility Management Entity (MME), Serving Gateway (S-GW), Packet Data Network Gateway (P-GW) in LTE, or their equivalent functions in Service-Based Architecture. The CN is essential for enabling IMS-based services such as VoLTE and VoWiFi, as it provides the critical control and connectivity infrastructure required for these advanced communication features to function.

The IP Multimedia Subsystem (IMS) architecture enables the

delivery of IP-based multimedia services across various network types, including both 3GPP (e.g., cellular) and non-3GPP (e.g., Wi-Fi) networks. Within this framework, IMS PDN (Packet Data Network) handover refers to the process of transferring an active IMS session between these different network types while maintaining service continuity. This is crucial for services like Voice over LTE (VoLTE) or Voice over Wi-Fi (VoWiFi).

The call setup and maintenance process in IMS involves a

series of SIP (Session Initiation Protocol) messages, including INVITE requests, provisional responses, and final responses. Various timers, such as Timer B for INVITE transactions and Timer F for non-INVITE transactions, are employed to manage call flow and detect network issues. When a handover is necessary, such as when a user moves out of Wi-Fi coverage during a VoWiFi call, the device initiates a complex process to transfer the IMS PDN connection. This involves re-establishing IMS registration on the new network, transferring active media streams, and maintaining imperceptible continuity of service. The entire process, from initial call setup to potential handover scenarios, is governed by 3GPP specifications, which define the precise procedures and signaling required between the device, access networks, and core network elements.

In this disclosure, the terms “3GPP network” and “cellular network” are used interchangeably to refer to mobile networks that adhere to standards defined by 3GPP, including but not limited to 4G LTE and 5G NR networks. Similarly, the terms “non-3GPP network” and “Wi-Fi network” are used interchangeably to refer to wireless local area networks that operate based on IEEE 802.11 standards, commonly known as Wi-Fi. These interchangeable terms are employed throughout the specification and claims to maintain consistency with various industry conventions while preserving the technical accuracy of the disclosed subject matter. The use of these interchangeable terms does not limit the scope of the invention to any particular network implementation, provided the network fulfills the described functional requirements.

For terms and techniques not specifically described, reference may be made to wireless communication standard documents (e.g., 3GPP specifications) issued before this specification.

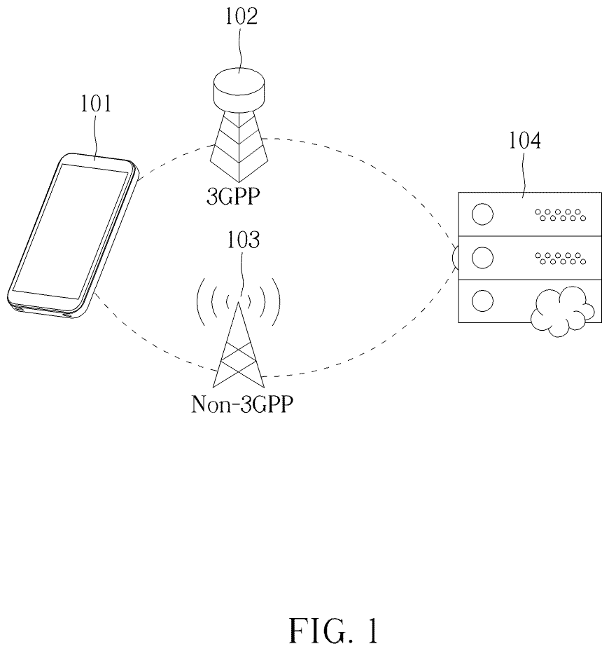

FIG. 1 depicts a scenario in which a UE 101 communicates with an IMS server 104. The UE 101, possessing the capability to maintain simultaneous connections to multiple network types, can establish a connection with the IMS server 104 via both a 3GPP network 102 (e.g., 4G, 5G cellular) and a non-3GPP network (i.e., Wi-Fi network) 103. The UE 101 communicates with an IMS server 104, which manages voice and multimedia services.

The 3GPP network 102 could be a 4G LTE or 5G network, providing wide-area mobile coverage. These networks are standardized by 3GPP and offer services like Voice over LTE (VoLTE) or Voice over New Radio (VoNR). The non-3GPP network 103 typically represents a Wi-Fi network. It could be a home Wi-Fi setup, public hotspot, or enterprise wireless network. Wi-Fi networks enable services like Voice over Wi-Fi (VoWiFi) or Wi-Fi callings.

The IMS server 104, depicted in FIG. 1, is an integral part of the core network architecture. It sits above the packet-switched domain of the core network and interfaces with various network elements. The IMS 104 server provides a standardized framework for delivering IP multimedia services, including voice calls (VoLTE/VoNR), video calls, and messaging services over packet-switched networks. For non-3GPP networks like Wi-Fi, the IMS server 104 similarly acts as the control point for multimedia services, enabling features such as Wi-Fi Calling (VoWiFi).

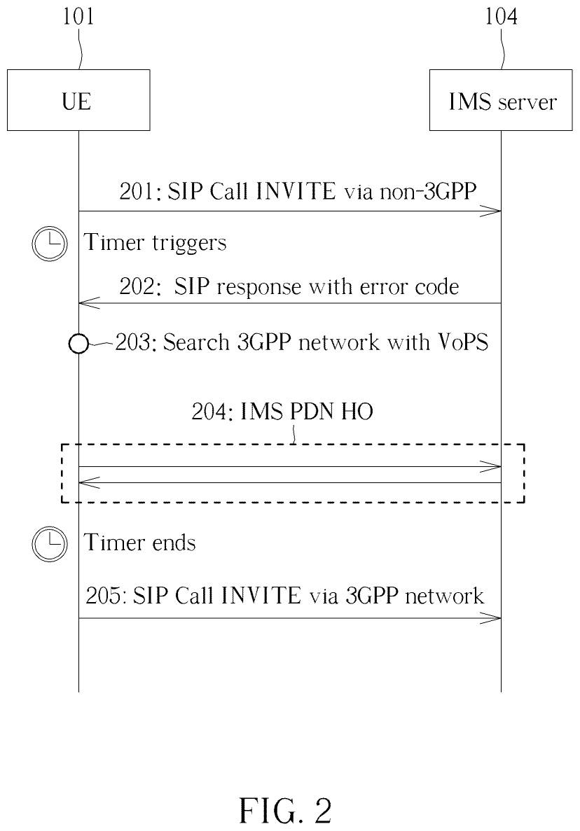

FIG. 2 depicts a message sequence diagram of UE 101 communicating with the network, specifically the IMS server 104, according to the embodiments. Initially, the UE is presumed to be connected to a non-3GPP network, such Wi-Fi network 103. The process begins with step 201, where the UE initiates an IMS call by sending a SIP Call INVITE message via this non-3GPP network to the network, which includes the IMS server 104. This represents the user's attempt to make a Wi-Fi call.

Following the transmission of the INVITE message, the UE initiates a timer to track the response latency from the IMS server 104. This timing mechanism remains active throughout the process, serving as a safeguard against prolonged delays or non-responses. The timer's role extends beyond merely waiting for the initial server response; it continues to operate during the subsequent steps, including the potential handover to a 3GPP network.

In step 202, the IMS server 104 responds to the INVITE with a SIP response containing an error code. This indicates that there's a problem with establishing the call over the Wi-Fi network 102. The nature of this error could vary, but it essentially means the Wi-Fi call cannot proceed as intended.

Upon receiving this error response, the UE 101 quickly moves to step 203. The UE immediately begins searching for a 3GPP network (cellular network) with voice capabilities, specifically Voice over Packet Switched (VoPS) capability. This is discrete action taken by the UE 101 to find an alternative network.

In step 204, an IMS PDN handover (HO) process is performed, indicating a series of exchanges to facilitate the handover from the non-3GPP (Wi-Fi) network 103 to the 3GPP (cellular) network 102. This step involves several sub-steps not detailed in the diagram, such as authentication, registration, and resource allocation on the new network.

Upon the successful completion of the IMS PDN Handover process, the timer concludes its function. This extended timing approach ensures that the entire transition process, from the initial INVITE to the finalization of the network handover, occurs within acceptable time parameters, maintaining the goal of providing a seamless and efficient user experience.

Finally, in step 205, once the handover to the 3GPP network 102 is complete, the UE 101 sends another SIP Call INVITE. This time, the INVITE is sent via the newly connected 3GPP network. This represents the UE's attempt to re-establish the call that failed on Wi-Fi network 103, now using the 3GPP network 102.

Although not explicitly shown in the figure, in the event that the IMS PDN handover process in step 204 is unsuccessful, the UE 101 would take alternative action. Specifically, it would terminate the SIP call attempt on the non-3GPP network (Wi-Fi) 103. This failsafe measure ensures that network resources are not unnecessarily tied up and prepares the UE 101 for potential retry attempts or alternative connection methods.

This sequence illustrates the core of the invention's approach: quickly detecting a failure in Wi-Fi calling, seamlessly transitioning to a cellular network, and retrying the call-all aimed at providing a smooth and uninterrupted experience for the user. The speed and automation of this process are the keys to making the transition as imperceptible as possible to the user.

In certain implementation of this system, the UE 101 may maintain simultaneous connections to both 3GPP and non-3GPP networks from the outset. This dual connectivity scenario enhances the efficiency of the handover process. When the UE 101 is already registered and connected to the 3GPP network 102 with voice capabilities alongside its connection to non-3GPP (Wi-Fi) network 103, the transition can be further optimized. In such cases, step 203, which involves searching for a 3GPP network with voice support, becomes redundant and can be bypassed.

However, it is important to note that mere connection to a 3GPP network does not guarantee voice service availability. In scenarios where the UE 101 is registered and connected to the 3GPP network 102, but that network lacks voice capabilities, the step 203 cannot be bypassed. This step 203, which involves searching for a 3GPP network specifically with voice support, remains necessary. It ensures that when transitioning from a failed Wi-Fi call, the UE 101 connects to a cellular network that can actually support voice services, maintaining seamless call continuity.

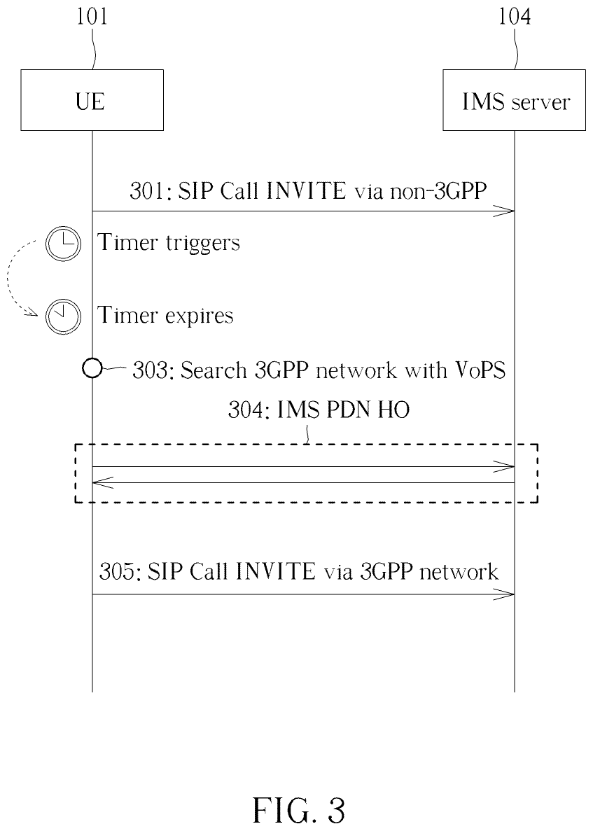

FIG. 3 depicts another message sequence diagram of UE 101 communicating with the network, specifically the IMS server 104, according to the embodiments. Initially, the UE is presumed to be connected to a non-3GPP network, such Wi-Fi network 103. The process begins with step 301, where the UE initiates an IMS call by sending a SIP Call INVITE message via this non-3GPP network to the network, which includes the IMS server 104. This represents the user's attempt to make a Wi-Fi call.

Immediately after sending this INVITE, a timer is triggered on the UE side. This timer serves to monitor the response time from the IMS server 104. If the timer initiated during the SIP Call INVITE (step 301) expires before receiving a valid response from the network, the UE 101 proceeds to step 303. In this scenario, instead of waiting for an explicit error code, the UE interprets the timeout as a failure in the Wi-Fi calling attempt. Consequently, it begins the process of searching for a 3GPP network with voice capabilities (VoPS).

The timer mechanism employed in this system is versatile and can take various forms depending on the specific implementation or network conditions. It may be configured as a SIP response timer, which monitors the time taken for the network to respond to the initial INVITE message. Alternatively, it could be set up as a call release timer, ensuring that resources are not indefinitely held for a potentially failed call attempt. In some cases, it might function as a call APP OOS (Out-of-Service) timer, detecting when the application loses connectivity. Another possibility is a call setup timer, which oversees the entire call establishment process. Regardless of the specific type, the primary function of this timer is to detect potential issues in the Wi-Fi calling process, serving as a fail-safe to trigger the transition to a 3GPP network when necessary.

The expiration of the timer indicates that there's a problem with establishing the call over the Wi-Fi network 102. The nature of this error could vary, but it essentially means the Wi-Fi call cannot proceed as intended.

Upon the expiration of the timer, the UE 101 quickly moves to step 303. The UE immediately begins searching for a 3GPP network (cellular network) with voice capabilities. This is discrete action taken by the UE 101 to find an alternative network.

In step 304, an IMS PDN handover process is performed, indicating a series of exchanges to facilitate the handover from the non-3GPP (Wi-Fi) network 103 to the 3GPP (cellular) network 102. This step involves several sub-steps not detailed in the diagram, such as authentication, registration, and resource allocation on the new network.

Finally, in step 305, once the handover to the 3GPP network 102 is complete, the UE 101 sends another SIP Call INVITE. This time, the INVITE is sent via the newly connected 3GPP network. This represents the UE's attempt to re-establish the call that failed on Wi-Fi network 103, now using the 3GPP network 102.

Although not explicitly shown in the figure, in the event that the IMS PDN handover process in step 304 is unsuccessful, the UE 101 would take alternative action. Specifically, it would terminate the SIP call attempt on the non-3GPP network (Wi-Fi) 103. This failsafe measure ensures that network resources are not unnecessarily tied up and prepares the UE 101 for potential retry attempts or alternative connection methods.

This sequence illustrates the core of the invention's approach: quickly detecting a failure in Wi-Fi calling, seamlessly transitioning to a cellular network, and retrying the call-all aimed at providing a smooth and uninterrupted experience for the user. The speed and automation of this process are the keys to making the transition as imperceptible as possible to the user.

In certain implementation of this system, the UE 101 may maintain simultaneous connections to both 3GPP and non-3GPP networks from the outset. This dual connectivity scenario enhances the efficiency of the handover process. When the UE 101 is already registered and connected to the 3GPP network 102 with voice capabilities alongside its connection to non-3GPP (Wi-Fi) network 103, the transition can be further optimized. In such cases, step 303, which involves searching for a 3GPP network with voice support, becomes redundant and can be bypassed.

However, it is important to note that mere connection to a 3GPP network does not guarantee voice service availability. In scenarios where the UE 101 is registered and connected to the 3GPP network 102, but that network lacks voice capabilities, the step 303 cannot be bypassed. This step 303, which involves searching for a 3GPP network specifically with voice support, remains necessary. It ensures that when transitioning from a failed Wi-Fi call, the UE 101 connects to a cellular network that can actually support voice services, maintaining seamless call continuity.

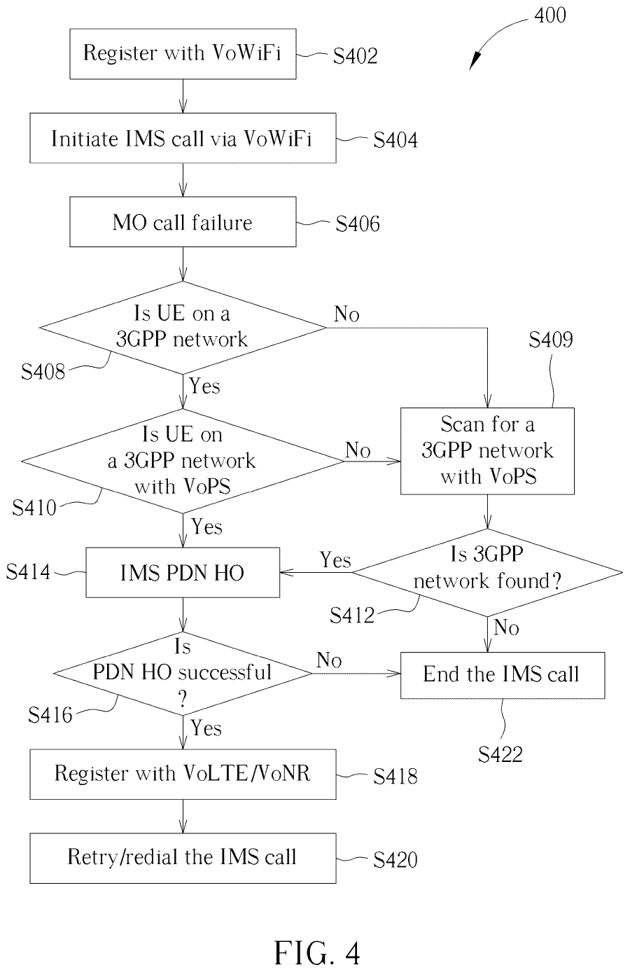

FIG. 4 depicts a flowchart of a call handover method 400 according to the embodiments, which essentially summarizes the above descriptions. The call handover method 400, performed by a UE (e.g., UE 101), includes the following steps:
S402: Register with VoWiFi;
S404: Initiate Mobile Originated (MO) call via VoWiFi;
S406: Experience an MO call failure;
S408: Determine whether the UE is registered to a 3GPP network; if so, proceed to step S410; if not, proceed to step S409;
S409: Scan for a 3GPP network; proceed to step S 412
S410: Determine whether the 3GPP network has VoPS capability; if so, proceed to step S414; if not, return to step S409;
S412: Determine whether a 3GPP network with VoPS capability is found; if so, proceed to step S414; if not, proceed to step S422;
S414: Initiate IMS PDN handover to the 3GPP network;
S416: Determine whether the IMS PDN handover is successful; if so, proceed to step S418; if not, proceed to step S422;
S418: Register with VoLTE or VoNR;
S420: Retry or redial the IMS call;
S422: End the IMS call.

It should be noted that MO call failure are usually caused by the following reason: receiving a SIP error response, experiencing a SIP response timeout, and/or experiencing a predefined call timer timeout. The timer may a SIP response timer, which monitors the time taken for the network to respond to the initial INVITE message. Alternatively, the timer could be a call release timer, ensuring that resources are not indefinitely held for a potentially failed call attempt. In some cases, the timer can function as a call APP OOS timer, detecting when the application loses connectivity. Another possibility is a call setup timer, which oversees the entire call establishment process.

The reliance on VoPS (Voice over Packet Switched) capability is critical for ensuring seamless and high-quality voice call continuity when transitioning from Wi-Fi to cellular networks. When a Wi-Fi call fails, the system aims to switch to a cellular network that can provide equivalent or better voice service. VoPS capability indicates that the 3GPP network can support voice calls over its packet-switched infrastructure, which is essential for technologies like VoLTE or VoNR (Voice over New Radio). These packet-switched voice technologies offer superior call quality, faster connection times, and more efficient use of network resources compared to traditional circuit-switched voice calls. By verifying VoPS capability, the method ensures that the handover is not just to any available cellular network, but specifically to one that can maintain or improve the voice call experience. This check prevents scenarios where the call might be transferred to a network that can only support data, or that would require falling back to older, less efficient voice technologies.

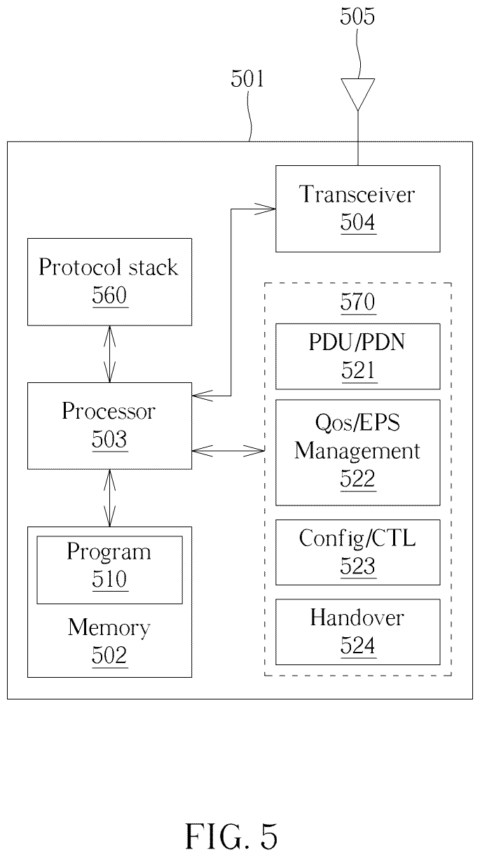

FIG. 5 depicts a simplified block diagram of a user equipment (UE) according to the embodiments. The UE 501 includes a memory 502, a processor 503, and a radio frequency (RF) transceiver 504. The RF transceiver 504, coupled to the antenna 505, receives RF signals from antenna 505, converts them to baseband signals, and sends them to the processor 503. The RF transceiver 504 also converts baseband signals received from the processor 503 into RF signals and transmits them via the antenna 505. The processor 503 processes the received baseband signals and invokes different functional modules and circuits to perform features in the UE 501. The memory 502 stores data and program instructions 510 to be executed by the processor 503 to control the operations of UE 501. The processor 503 may be implemented with, for example, a special purpose processor, a digital signal processor (DSP), multiple micro-processors, one or more micro-processors combined with a DSP core, a controller, a microcontroller, application specific integrated circuits (ASICs), field programmable gate arrays (FPGAs), other types of integrated circuits (ICs), and/or state machines. The processor 503 with software can be used to implement and configure features of UE 501.

The UE 501 is further equipped with a set of functional modules and control circuits that enable it to perform its tasks, including protocol stacks 560 comprising Non-Access-Stratum (NAS) layer for communicating with core network entities (AMF/SMF/MME), Radio Resource Control (RRC) layer for high-level configuration and control, Packet Data Convergence Protocol/Radio Link Control (PDCP/RLC) layer, Media Access Control (MAC) layer, and Physical (PHY) layer, as well as system modules and circuits 570 that can be implemented using software, firmware, hardware, or a combination thereof, and when executed by the processors using program instructions stored in memory, interwork with each other to enable UE 501 to perform embodiments, functional tasks, and features within the network.

The system modules and circuits 570 comprise several key components that collaboratively manage PDU sessions, PDN connections, QoS flows, EPS bearers, and handle mobility. The PDU session and PDN connection handling circuit 521 executes procedures to establish and modify PDU sessions in 5G and PDN connections in 4G, while the QoS flow and EPS bearer handling circuit 522 manages the lifecycle of QoS flows in 5G and their mapped EPS bearer contexts in 4G. The configuration and control circuit 523 handles various configuration and control parameters related to mobility management and session management functions, and the handover module 524 manages handover and inter-system change procedures to ensure seamless transition of PDU sessions and QoS flows when the device moves between 5G and 4G coverage, enabling efficient management of multi-access connectivity, QoS, and mobility between 5G and 4G networks.

The various embodiments of the present disclosure addresses a common issue with Wi-Fi calling (VoWiFi)-its potential instability or failure due to various factors such as poor Wi-Fi signal, network congestion, or connection drops. By implementing an intelligent and automated system to detect VoWiFi call failures and seamlessly transition to cellular networks, the invention ensures call continuity. This means users are less likely to experience dropped calls or failed call attempts when using Wi-Fi calling, significantly improving overall call reliability and user satisfaction.

The embodiments also present an optimization of network resource utilization. By quickly identifying when a Wi-Fi call is failing and swiftly transitioning to a cellular network with suitable voice capabilities (VoPS), it ensures that calls are always routed through the most appropriate and efficient channel available. This not only improves the quality of service for the end-user but also helps in load balancing across different network types, potentially reducing congestion on any single network.

Finally, the embodiments represent enhanced user experience by making the transition between Wi-Fi and cellular networks as seamless and imperceptible as possible. Users do not need to manually intervene or redial when their Wi-Fi call encounters issues. Instead, the system automatically handles the complexities of network switching, call handover, and re-establishment. This seamless operation maintains the illusion of a single, unified communication system for the user, despite the complex interplay of different network technologies working behind the scenes. Such transparency in operation can significantly boost user confidence in the reliability of their communication services, regardless of the underlying network technology in use.

For clarity in this specification, certain terminological conventions are observed. The singular forms “a”, “an”, and “the” are intended to encompass plural forms as well, unless the context clearly indicates otherwise. The term “and/or” refers to and encompasses any and all possible combinations of one or more of the associated listed items. The terms “includes,” “including,” “comprises,” and “comprising” specify the presence of stated features, integers, steps, operations, elements, and/or components, but do not preclude the presence or addition of one or more other features, integers, steps, operations, elements, components, and/or groups thereof.

The term “exemplary” is used herein to mean “serving as an example, instance, or illustration” and should not be construed as necessarily preferred or advantageous over other aspects or designs.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some”refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in “communication” with another entity or entities, it implies the capability of sending and/or receiving electrical signals, which may contain image/voice or data/control information, regardless of whether these signals are analog or digital in nature.

In the context of this patent specification, the term “user equipment” (UE) encompasses a broad range of devices possessing radio communication capabilities. This definition includes, but is not limited to, smartphones (specifically, handheld touchscreen mobile computing devices capable of connecting to one or more cellular networks), Personal Data Assistants (PDAs), pagers, laptop computers, desktop computers, wireless handsets, and any computing device equipped with a wireless communications interface. User equipment may also be referred to by various alternative terms, including but not limited to: client, mobile device, mobile terminal, user terminal, mobile unit, mobile station, mobile user, subscriber, user, remote station, access agent, user agent, receiver, radio equipment, reconfigurable radio equipment, or reconfigurable mobile device. These terms should be considered interchangeable within the context of this document.

The scope of UEs also extends to Internet of Things (IoT) devices. IoT UEs are characterized by a network access layer specifically designed for low-power IoT applications that typically involve short-lived UE connections. These IoT UEs may employ various technologies for data exchange, including Machine-to-Machine (M2M), Machine Type Communication (MTC), or massive MTC (mMTC). Such data exchanges may occur with an MTC server or device via a Public Land Mobile Network (PLMN), with other UEs using Proximity Services (ProSe) or Device-to-Device (D2D) communications, or through sensor networks or IoT networks. It is noteworthy that M2M or MTC data exchanges are often initiated by the machine itself rather than by human intervention.

An IoT network, as referenced in this specification, describes an interconnected system of IoT UEs. These UEs may include uniquely identifiable embedded computing devices integrated within the broader Internet infrastructure. IoT UEs may execute background applications, such as keep-alive messages or status updates, to maintain and facilitate the connections within the IoT network.

UEs are configured to establish communicative coupling with Radio Access Networks (RANs) through a radio interface. This radio interface is a physical communication interface or layer designed to operate with various cellular communication protocols. These protocols may include, but are not limited to, Global System for Mobile Communications (GSM) protocol, Code Division Multiple Access (CDMA) network protocol, Push-to-Talk (PTT) protocol, PTT over Cellular (POC) protocol, Universal Mobile Telecommunications System (UMTS) protocol, 3rd Generation Partnership Project Long-Term Evolution (3GPP LTE) protocol, 5G protocol, and New Radio (NR) protocol.

As a specific example, a UE and a RAN may utilize a Uu interface (such as an LTE-Uu interface) to exchange control plane data. This exchange occurs via a protocol stack comprising multiple layers: a Physical (PHY) layer, a Medium Access Control (MAC) layer, a Radio Link Control (RLC) layer, a Packet Data Convergence Protocol (PDCP) layer, and a Radio Resource Control (RRC) layer. In this context, a Downlink (DL) transmission refers to data sent from the RAN to the UE, while an Uplink (UL) transmission refers to data sent from the UE to the RAN.

Furthermore, UEs may employ a sidelink for direct communication with other UEs, facilitating D2D, Peer-to-Peer (P2P), and/or ProSe communication. A ProSe interface, for instance, may incorporate one or more logical channels. These channels include, but are not limited to, a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The various aspects described herein may be implemented using a variety of hardware and software components. These may include processors, Digital Signal Processors (DSPs), Application Specific Integrated Circuits (ASICs), Field Programmable Gate Arrays (FPGAs) or other programmable logic devices, discrete gates or transistor logic, or discrete hardware components. A processor in this context may be a microprocessor, but could also be any conventional processor, controller, microcontroller, or state machine. Processors may also be implemented as combinations of computing devices, such as a combination of a DSP and a microprocessor, multiple microprocessors, one or more microprocessors in conjunction with a DSP core, or any other such configuration.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

The aspects described in this specification can be implemented through both hardware and software instructions. These instructions may be stored on various types of computer-readable media, including but not limited to Random Access Memory (RAM), flash memory, Read Only Memory (ROM), Electrically Programmable ROM (EPROM), Electrically Erasable Programmable ROM (EEPROM), registers, hard disks, removable disks, CD-ROMs, or any other form of storage medium known in the art. In a typical configuration, the storage medium is connected to a processor, enabling the processor to read information from and write information to the medium. In some configurations, the storage medium may be integral to the processor itself.

In some embodiments, the computing instructions may be executed by an operating system, which may include but is not limited to Microsoft Windows, Apple Mac OS X, macOS or iOS, various distributions of the Linux operating system, or Google Android operating system.

Some embodiments may involve computers on a distributed computing network, such as a network with multiple clients and/or servers. In such embodiments, clients may run software implementing client-side portions of the described systems and methods, while servers handle requests from these clients. Communication between clients and servers may occur via one or more electronic networks, which may include the Internet, wide area networks, mobile telephone networks, wireless networks (e.g., Wi-Fi, 5G), or local area networks, implemented using any known network protocols.

In implementations where the systems described in this specification collect user information, provisions may be made to protect user privacy and data. Specifically, users may be afforded the opportunity to opt in or out of programs or features that collect personal information, such as data related to user preferences or smart device usage patterns. Furthermore, in certain embodiments, data protection measures may be implemented to anonymize collected information prior to storage or utilization. For instance, a user's identity may be anonymized to prevent the determination or association of personally identifiable information with that specific user. Additionally, user preferences and interaction data may be generalized, potentially based on broader demographic categories, rather than being linked to individual users.

It should be noted that the operational steps described in any exemplary aspects within this specification are provided as examples and for discussion purposes. These operations may be performed in numerous different sequences other than the illustrated sequences. Furthermore, operations described in a single step may actually be performed as multiple distinct steps, and multiple steps may be combined into a single operational step. The steps in the appended figures may be subject to numerous modifications as will be apparent to those skilled in the art.

Some embodiments may incorporate all explicitly disclosed features as well as additional features that, while not specifically described herein, are compatible with and enhance the core invention. Conversely, other embodiments may selectively omit certain non-disclosed elements, either partially or in their entirety, while still falling within the scope of the invention. This flexibility in feature inclusion or exclusion allows for a range of implementations tailored to specific applications or requirements, without departing from the fundamental principles of the invention.

The logical stages illustrated in the drawings may be reordered, combined, or broken out if they are not order-dependent. The ordering and groupings presented in this specification are not exhaustive, and other arrangements will be apparent to those skilled in the art. These stages may be implemented in hardware, firmware, software, or any combination thereof.

The drawings and descriptions provided in this specification offer detailed illustrations of various embodiments of the invention. However, it should be understood by those skilled in the art that these embodiments can be implemented without necessarily adhering to every specific detail provided herein. In some instances, well-established methods, procedures, components, and circuits have been mentioned without elaborate explanations to avoid obscuring the key aspects of the embodiments. It is important to note that the figures presented in this specification, including any component diagrams, are intended for illustrative purposes and may not be drawn to scale. This allows for a clear presentation of the inventive concepts while leaving room for variations and adaptations within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of call handover, performed by a user equipment (UE), comprising:
initiating a mobile originating (MO) call using a Voice over Wi-Fi (VoWiFi) service;
detecting a failure of the MO call using the VoWiFi service;
determining whether voice calling is supported by a cellular network in response to detecting the failure;
performing a handover of an IP Multimedia Subsystem (IMS) Packet Data Network (PDN) connection from a Wi-Fi network to the cellular network if the voice calling is supported by the cellular network; and
retrying the MO call using the cellular network.

2. The method of claim 1, further comprising:
establishing a connection to both the Wi-Fi network and the cellular network; and
registering the UE for the VoWiFi service.

3. The method of claim 1, further comprising determining whether the UE is registered to the cellular network in response to detecting the failure.

4. The method of claim 3, further comprising scanning for at least one cellular network with voice capability if the UE is not registered with the cellular network.

5. The method of claim 1, wherein the failure of the MO call comprises at least one of:
receiving a Session Initiation Protocol (SIP) error response;
experiencing a SIP response timeout; or experiencing a predefined call timer timeout.

6. The method of claim 1, further comprising scanning for at least one cellular network with voice capability if the voice calling is not supported by the cellular network.

7. The method of claim 6, further comprising terminating the MO call if the at least one cellular network with voice capability is not detected.

8. The method of claim 1, further comprising registering the UE for a Voice over LTE (VoLTE) service or a Voice over New Radio (VoNR) service.

9. The method of claim 1, further comprising:
determining whether the handover of the IMS PDN connection is successful; and
terminating the MO call if the handover of the IMS PDN connection is successful.

10. The method of claim 1, wherein the cellular network uses a Radio Access Technology (RAT) defined by 3GPP.

11. A user equipment (UE), comprising:
a memory; and
a processor coupled to the memory, configured to:
initiate a mobile originating (MO) call using a Voice over Wi-Fi (VoWiFi) service;
detect a failure of the MO call via the VoWiFi service;
determine whether voice calling is supported by a cellular network in response to detecting the failure;
perform a handover of an IP Multimedia Subsystem (IMS) Packet Data Network (PDN) connection from a Wi-Fi network to the cellular network if the voice calling is supported by the cellular network; and
retry the MO call using the cellular network.

12. The UE of claim 11, wherein the processor is further configured to:
establish a connection to both the Wi-Fi network and the cellular network; and
register the UE for the VoWiFi service.

13. The UE of claim 11, wherein the processor is further configured to determine whether the UE is registered to the cellular network in response to detecting the failure.

14. The UE of claim 13, wherein the processor is further configured to scan for at least one cellular network with voice capability if the UE is not registered with the cellular network.

15. The UE of claim 11, wherein the failure of the MO call comprises at least one of:
receiving a Session Initiation Protocol (SIP) error response;
experiencing a SIP response timeout; and
experiencing a predefined call timer timeout.

16. The UE of claim 11, wherein the processor is further configured to scan for at least one cellular network with voice capability if the voice calling is not supported by the cellular network.

17. The UE of claim 16, wherein the processor is further configured to terminate the MO call if the at least one cellular network with voice capability is not detected.

18. The UE of claim 11, wherein the processor is further configured to register the UE for a Voice over LTE (VoLTE) service or a Voice over New Radio (VoNR) service.

19. The UE of claim 11, wherein the processor is further configured to:
determining whether the handover of the IMS PDN connection is successful; and
terminating the MO call if the handover of the IMS PDN connection is successful.

20. The UE of claim 11, wherein the cellular network uses a Radio Access Technology (RAT) defined by 3GPP.
